(19) United States
(12) Patent Application Publication
(10) Pub. No.: US 2012/0199456 A1
(43) Pub. Date: Aug. 9, 2012

(54) SPRING ACTUATOR FOR CIRCUIT BREAKER

(75) Inventor: Sung Jun TAK, Cheongju-Si (KR)

(73) Assignee: LSIS CO., LTD., Anyang (KR)

(21) Appl. No.: 13/363,281

(22) Filed: Jan. 31, 2012

(30) Foreign Application Priority Data
Feb. 8, 2011 (KR) 10-2011-0011247

(51) Int. Cl. H01H 5/06

(52) U.S. Cl. 200/400

(57) ABSTRACT

Disclosed is a spring actuator for a circuit breaker, the spring actuator comprises a spring configured to provide an elastic energy serving to perform a circuit opening operation or a circuit closing operation of a circuit breaker; a spring housing providing a space to compress or extend the spring; a movable supporting plate linearly movable in the spring housing; a linearly-movable shaft linearly-movable having a first position for charging an elastic energy by compressing the spring, and having a second position for releasing the spring; a driving mechanism configured to provide a rotatory power for linearly-moving the linearly-movable shaft; one rigid link configured to convert the rotatory power provided from the driving mechanism to a linear power and to transmit the linear power to the linearly-movable shaft; and a latch mechanism having a position for latching the spring such that the spring maintains a charged state.

### CROSS-REFERENCE TO RELATED APPLICATION

Pursuant to 35 U.S.C. §119(a), this application claims the benefit of earlier filing date and right of priority to Korean Patent Application No. 10-2011-0011247, filed on Feb. 8, 2011, the contents of which are hereby incorporated by reference herein in their entirety.

### BACKGROUND OF THE INVENTION

1. Field of the Invention

The present disclosure relates to a circuit breaker, and particularly, to a spring actuator for a circuit breaker capable of charging or discharging a closing spring configured to provide a driving power for closing the circuit breaker, and a trip spring configured to provide a driving power for opening the circuit breaker.

2. Background of the Invention

An air circuit breaker (abbreviated as ACB hereinafter) and a vacuum circuit breaker (abbreviated as VCB hereinafter) use a mechanical actuator for opening or closing a circuit, respectively. Here, the ACB is installed at an incoming side of a large electric power system such as a factory, and is configured to open or close an electric power circuit on which a rated voltage higher than that of a general circuit breaker is applied. And, the VCB is configured to open or close an electric power circuit on which a much higher voltage or an ultra-high voltage is applied.

In the occurrence of an accident current such as a short circuit current or an over-current on the electric power circuit, the electric power circuit has to be instantaneously broken. In this case, a spring actuator using an elastic energy of a spring is generally used as the mechanical actuator. More concretely, in a circuit breaker used to open or close an electric power circuit on which power of a high voltage is applied, an elastic energy is charged to a closing spring or a trip spring in a manual manner or in a motor-operated manner, by an additional spring actuator. During a closing operation or a trip operation, an elastic energy charged to the closing spring or the trip spring is discharged to contact a movable contactor to a fixed contactor (closing operation), or to disconnect the movable contactor from the fixed contactor (trip operation, in other words opening operation).

The conventional spring actuator for a circuit breaker comprises a driving source configured by a ratchet wheel or a cam device driven manually or by a motor to which a driving shaft of the ratchet wheel or the cam device is connected, a chain movable in a connected state to the driving source, a compression plate connected to the chain, a closing spring or a trip spring compressed by pressing the compression plate or extended by releasing the compression plate, a guide roller configured to guide a movement of the chain, a latch mechanism configured to lock the closing spring or the trip spring having a charged elastic energy or to release the locked state.

In the conventional spring actuator, the driving source of the ratchet wheel or the cam device rotates as the driving shaft rotates manually or by a motor, the chain connected to the driving source is moved toward the driving source. As a result, the compression plate connected to the chain compresses the closing spring or the trip spring, thereby allowing the closing spring or the trip spring to charge an elastic force to perform a closing operation or a trip operation.

As the closing spring or the trip spring discharges the charged elastic energy by being extended by release of the latch mechanism, the elastic energy is used to close or open the electric power circuit of the circuit breaker.

However, the conventional spring actuator has the following problems.

Firstly, during a charging operation of the spring and during a closing or trip operation using a discharged elastic energy of the spring, an elastic force of the spring is applied to a guide roller as a load. As the chain and the guide roller irregularly contact each other, the guide roller may be damaged or deformed. This may degrade the durability and the reliability of the spring actuator.

Furthermore, in case of changing (e.g., increasing) an elastic energy outputted from the spring actuator, a characteristic of the chain, e.g., a tensile strength has to be also changed.

However, a manufacturer of the circuit breaker who uses limited types of chains presented on the market has a difficulty in changing the characteristic of the chain. This may result in a difficulty in product improvements or design changes for enhancing an output from the spring actuator.

### SUMMARY OF THE INVENTION

Therefore, an aspect of the detailed description is to provide a spring actuator for a circuit breaker capable of enhancing the durability and the reliability and capable of freely changing a design for an increased output, without using a chain and a guide roller.

To achieve these and other advantages and in accordance with the purpose of this specification, as embodied and broadly described herein, there is provided a spring actuator for a circuit breaker, the spring actuator comprising:

a spring configured to provide an elastic energy serving as a driving power to perform a circuit opening operation or a circuit closing operation of a circuit breaker;

a spring housing configured to support one end of the spring, and providing a space to compress or extend the spring;

a movable supporting plate configured support another end of the spring, and linearly movable in the spring housing;

a linearly-movable shaft linearly-movable together with the movable supporting plate in a connected state to the movable supporting plate, having a first position for charging an elastic energy serving as a driving power to perform a circuit opening operation or a circuit closing operation of a circuit breaker by compressing the spring, and having a second position for releasing the spring such that the spring discharges the charged elastic energy;

a driving mechanism configured to provide a rotatory power for linearly-moving the linearly-movable shaft;

a rigid link having one end connected to the driving mechanism and another end connected to the linearly-movable shaft, and configured to convert the rotatory power provided from the driving mechanism to a linear power and to transmit the linear power to the linearly-movable shaft; and

a latch mechanism having a position for latching the spring such that the spring maintains a charged state, and having a position for releasing the spring such that the spring discharges the charged elastic energy.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a longitudinal sectional view showing a configuration of a closing spring actuator according to a preferred embodiment of the present disclosure, in which a closing spring is in a discharged state;

FIG. 2 is a longitudinal sectional view showing a configuration of a closing spring actuator according to a preferred embodiment of the present disclosure, in which a closing spring is in a charged state;

FIG. 3 is a longitudinal sectional view showing a configuration of a trip spring actuator according to a preferred embodiment of the present disclosure, in which a trip spring is in a discharged state; and

FIG. 4 is a longitudinal sectional view showing a configuration of a trip spring actuator according to a preferred embodiment of the present disclosure, in which a trip spring is in a charged state.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

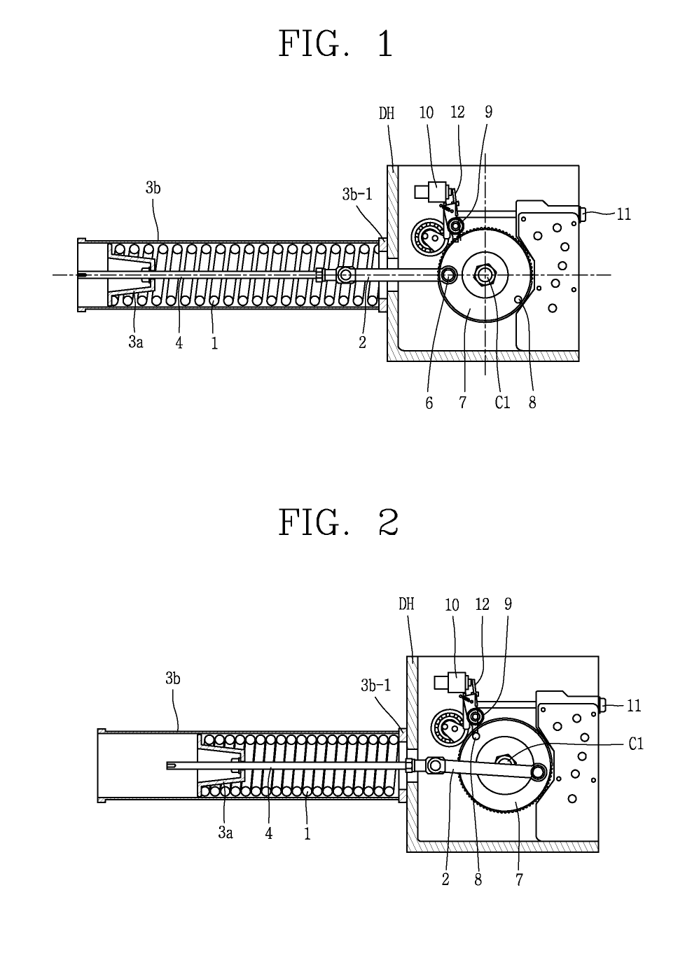

As shown, a spring actuator for a circuit breaker according to a preferred embodiment of the present disclosure comprises a closing spring actuator and a trip spring actuator, and a configuration of the spring actuator for a circuit breaker will be explained with reference to FIGS. 1 to 4.

The spring actuator for a circuit breaker according to a preferred embodiment of the present disclosure comprises springs 1 and 21, spring housings 3b and 23b, movable supporting plates 3a and 23a, linearly-movable shafts 4 and 24, driving mechanism 7, 7a, 31 and 31a, links 2 and 22, and a latch mechanism 8, 9, 10, 11, 12, 28, 32, 33, 34, 35 and 36.

The springs 1 and 21 are configured to provide an elastic energy, a driving power for performing a circuit opening operation or a circuit closing operation of the circuit breaker.

The spring housings 3b and 23b are configured to support one end of the springs 1 and 21, and to provide a space where the springs 1 and 21 are compressed or extended.

The movable supporting plates 3a and 23a are configured to support another end of the springs 1 and 21, and are linearly-movable in the spring housings 3b and 23b.

The linearly-movable shafts 4 and 24 are linearly-movable together with the movable supporting plates 3a and 23a in a connected state to the movable supporting plates 3a and 23a, and have a first position for charging an elastic energy serving as a driving power to perform a circuit opening operation or a circuit closing operation of the circuit breaker by compressing the springs 1 and 21, and a second position for releasing the springs 1 and 21 such that the springs 1 and 21 discharge the charged elastic energy.

The driving mechanism 7, 7a, 31 and 31a is configured to provide a rotatory power for linearly-moving the linearly-movable shafts 4 and 24.

The rigid links 2 and 22 have one end connected to the driving mechanism 7, 7a, 3a and 31a and another end connected to the linearly-movable shafts 4 and 24, and are configured to convert the rotatory power provided from the driving mechanism 7, 7a, 31 and 31a to a linear power and to transmit the linear power to the linearly-movable shafts 4 and 24.

The latch mechanism has a position for latching the springs 1 and 21 such that the springs 1 and 21 maintain a charged state, and have a position for releasing the springs 1 and 21 such that the springs 1 and 21 discharge the charged elastic energy.

A configuration of a closing spring actuator for a circuit breaker according to a preferred embodiment of the present disclosure will be explained with reference to FIGS. 1 and 2.

The closing spring actuator for a circuit breaker according to a preferred embodiment of the present disclosure comprises a closing spring 1, a first spring housing 3b, a first movable supporting plate 3a, a first linearly-movable shaft 4, a first driving mechanism 7 and 7a, a first rigid link 2, and a first latch mechanism 8, 9, 10, 11 and 12.

Referring to FIGS. 1 and 2, reference numeral 3b-1 designates flange portions of the first spring housing 3b, which are formed at one end of the first spring housing 3b and extending toward the center (inside) and the outside of the first spring housing 3b.

The flange portions 3b-1 support one end of the closing spring 1, and are fixed to a driving mechanism housing (DH) communicated with the first spring housing 3b by welding or by using coupling means (e.g., bolts and nuts).

The flange portions 3b-1 have a communication opening for communication with the driving mechanism housing (DH), through which the first rigid link 2 is movable.

Referring to FIGS. 1 and 2, reference numeral 6 designates a first connection pin configured to connect the first linearly-movable shaft 4 and the first rigid link 2 to each other.

The closing spring 1 is a means to provide an elastic energy, a driving power for performing a circuit closing operation of the circuit breaker. In the present disclosure, the closing spring 1 is configured by a compression spring which charges an elastic energy when being compressed, and discharges a charged elastic energy when being extended.

The first spring housing 3b is configured by a hollow pipe, and has two open ends. As aforementioned, the flange portions 3b-1 are disposed at one end of the first spring housing 3b, thereby supporting the one end of the closing spring 1.

The first movable supporting plate 3a is configured to support another end of the closing spring 1. The first movable supporting plate 3a may be configured by a bell-shaped metallic plate having an outer diameter smaller than an inner diameter of the first spring housing 3b by a predetermined allowance, and having a predetermined thickness.

Referring to FIGS. 1 and 2, flange portions are provided at the left upper and lower ends of the first movable supporting plate 3a, thereby supporting another end of the closing spring 1.

The first movable supporting plate 3a has, at a central portion thereof, a threaded through hole portion meshed with a threaded surface of the first linearly-movable shaft 4 for coupling with the first linearly-movable shaft 4. Here, the threaded through hole portion allows the first linearly-movable shaft 4 to penetrate therethrough.

Nuts (not shown) may be additionally provided so as to prevent the first movable supporting plate 3a from being moved back by an elastic force of the closing spring 1.

The first linearly-movable shaft 4 is configured by a linear shaft connected to the first movable supporting plate 3a and linearly-movable together with the first movable supporting plate 3a, and is provided with a threaded surface on an outer surface thereof.

The first linearly-movable shaft 4 has a first position (i.e., the position of FIG. 2) for charging an elastic energy serving as a driving power to perform a circuit closing operation of the circuit breaker by compressing the closing spring 1, and has a second position (i.e., the position of FIG. 1) for releasing the closing spring 1 so that the closing spring 1 can discharge the charged elastic energy.

The first driving mechanism 7 and 7a configured to provide a rotatory power for linearly-moving the first linearly-movable shaft 4 comprise a wheel shaft 7a, and a ratchet wheel 7 supported by the wheel shaft 7a.

The wheel shaft 7a may be rotated in a manual manner or in a motor-operated manner by being connected to a handle (not shown) or a motor (not shown).

The ratchet wheel 7 is rotatable according to rotation of the wheel shaft 7a, and has teeth on an outer circumferential surface thereof.

The first rigid link 2 has one end connected to the ratchet wheel 7 of the first driving mechanism 7 and 7a, and another end connected to the first linearly-movable shaft 4, so that a rotatory power provided from the ratchet wheel 7 of the first driving mechanism 7 and 7a can be converted into a linear power and the linear power can be transmitted to the first linearly-movable shaft 4.

The first rigid link 2 and the first linearly-movable shaft 4 are connected to each other by a joint member (not shown) and a connection pin (not shown).

The joint member is configured by a pipe-type metallic member. One end of the joint member has a threaded connection portion meshed with the threaded surface of the first linearly-movable shaft 4 as an inner surface thereof is configured by a threaded portion, and another end of the joint member link-connected to the first rigid link 2 by a connection pin so as to allow rotation of the first rigid link 2. Accordingly, the first rigid link 2 is rotatable centering around the connection pin.

A rotation range of the first rigid link 2 may be limited by a diameter of a through hole formed at the driving mechanism housing (DH) and configured to allow the first rigid link 2 to be movable by penetrating therethrough.

Preferably, the first rigid link 2 is configured by a linear link (in other words a straight link).

As can be seen from the dot-and-dash line of FIG. 1, the centers of the closing spring 1, the first linearly-movable shaft 4 and the first rigid link 2 are positioned at the same height as the center (C1) of the ratchet wheel 7. Under this configuration, a rotatory power of the ratchet wheel 7 may be transmitted to the closing spring 1 in a straight line manner, through the first rigid link 2, the first linearly-movable shaft 4 and the first movable supporting plate 3a, and a power loss can be minimized.

Since the first rigid link 2 is configured by a linear link, the structure to convert a rotatory power into a linear power and to transmit the linear power to the first linearly-movable shaft 4 may be simplified. This may enhance the reliability, and facilitate the fabrication and the design of the spring actuator for a circuit breaker.

The first latch mechanism 8, 9, 10, 11 and 12 have a position for latching the closing spring 1 so that the closing spring 1 can maintain a charged state, and have a position for releasing the closing spring 1 so that the closing spring 1 can discharge the charged elastic energy.

The first latch mechanism 8, 10, 11 and 12 comprise a latch pin 8, a first latch 9, a closing coil 10, a closing button 11 and a second latch 12.

The latch pin 8 is fixedly-installed at a position on a plate surface of the ratchet wheel 7, the position close to an outer circumferential surface of the ratchet wheel 7.

The first latch 9 is configured by a lever rotatable centering around a rotation shaft, and is installed at a position outside the ratchet wheel 7 and connectable to the latch pin 8. The position of the first latch 9 is predetermined so that the first latch 9 can stop rotation of the ratchet wheel 7 by contacting the latch pin 8, at a rotation angle of the ratchet wheel 7 where the closing spring 1 is compressed to charge a largest elastic energy.

The first latch 9 is elastically pressed so as to be rotatable from a second position where one end of the first latch 9 overlaps the ratchet wheel 7, to a first position where the first latch 9 is separated from the ratchet wheel 7, so that the latch pin 8 can be released by a bias spring (not shown) to which another end of the first latch 9 has been connected.

Unless a predetermined external force is applied, the first latch 9 is disposed at the first position where one end of the first latch 9 does not overlap the ratchet wheel 7, so that the one end of the first latch 9 can release the latch pin 8 by the bias spring.

When being pressed by the second latch 12, the first latch 9 overcomes an elastic pressure of the bias spring. Then, the first latch 9 rotates, from the first position, to a second position where the latch pin 8 is latched so that the ratchet wheel 7 can be prevented from rotating.

The second latch 12 comprises a central shaft portion having a semicircular section and configured to press the first latch 9 in a contact manner or configured to release the first latch 9, one end extending from the central shaft portion so as to receive a manual power from the closing button 11 and connected to the closing button 11, and another end extending to the closing coil 10 so as to receive a driving power from the closing coil 10.

The second latch 12 may be configured by a lever rotatable about the central shaft portion.

As one end of the second latch 12 is connected to the closing button 11 for power transmission, the second latch 12 may rotate to press the first latch 9 in a contact manner when the closing button 11 is pressed.

The second latch 12 is disposed at a position where the first latch 9 is latched when a planar part of a semicircle of the central shaft portion is toward the first latch 9, and is disposed at a position where the first latch 9 is released when a curve part of the semicircle of the central shaft is toward the first latch 9.

Referring to FIGS. 1 and 2, the closing button 11 is connected to the second latch 12 of the first latch mechanism 8, 9, 10, 11 and 12, and allows a user to perform a circuit closing operation of the circuit breaker. And, the closing button 11 is configured to transmit a user's pressing power to the second latch 12.

The closing coil 10 comprises a coil (not shown) configured to generate an electromagnetic force by being magnetized by an electric control signal, a plunger (not shown) linearly-movable by an electromagnetic force generated from the coil, and a return spring (not shown) configured to return the plunger to an initial position.

Once the coil is magnetized by an electric control signal provided from a controller (not shown), the plunger forward linearly-moves to a position protruded to the outside of the closing coil 10 by an electromagnetic force generated from the coil.

Once the coil is demagnetized as the supply of the electric control signal from the controller (not shown) is stopped, the plunger backward linearly-moves to a non-protruded position from the protruded position by an elastic force of the return spring.

The operation of the closing spring actuator according to a preferred embodiment of the present disclosure will be explained.

Firstly, a charging operation of the closing spring will be explained.

Referring to FIG. 1, once the ratchet wheel 7 is counterclockwise rotated by a handle (manipulated by a user) or a motor, a first connection pin 6 installed at one plate surface of the ratchet wheel 7 is also counterclockwise rotated.

As a result, one end of the first rigid link 2 connected to the first connection pin 6 is also counterclockwise rotated together with the ratchet wheel 7.

As the one end of the first rigid link 2 connected to the first connection pin 6 is also counterclockwise rotated together with the ratchet wheel 7, the first rigid link 2 linearly moves to the right side as shown in FIG. 6. As a result, the first linearly-movable shaft 4 connected to another end of the first rigid link 2, and the first movable supporting plate 3a connected to the first linearly-movable shaft 4 linearly move to the right side. This may cause the closing spring 1 to be compressed to charge an elastic energy.

Here, the first latch 9 is in a latched state since a planar part of a semicircle of the central shaft of the second latch 12 is toward the first latch 9. Accordingly, the first latch 9 counterclockwise rotates to be disposed at a second position for latching the latch pin 8 so that the ratchet wheel 7 cannot be rotated.

The latch pin 8 of the ratchet wheel 7 which is counterclockwise rotating comes in contact with the first latch 9. As a result, the rotation of the ratchet wheel 7 is stopped, and the closing spring 1 maintains the charged state (closing standby state).

Next, will be explained a discharging operation of the closing spring for a closing operation of the circuit breaker.

In the closing standby state of FIG. 2, the plunger may move to a position protruded to the outside of the closing coil 10 as the closing coil 10 is magnetized by an electric control signal provided from a controller (not shown) of the circuit breaker. Alternatively, a power of the closing button 11 may be transmitted to the second latch 12 when the closing button 11 is pressed by a user. In this case, the second latch 12 is pressed to rotate, because the plunger is pressed by the closing coil 10 contacting another end of the second latch 12, or because a power of the closing button 11 pressed by a user is transmitted to one end of the second latch 12.

As a curve part of the semicircle of the central shaft of the second latch 12 is toward the first latch 9 to release the first latch 9, the first latch 9 clockwise rotates so that the latch pin 8 can be released by the bias spring, from a position where one end of the first latch 9 overlaps the ratchet wheel 7, to a position where the first latch 9 does not overlap the ratchet wheel 7.

As a result, the ratchet wheel 7 is released to clockwise rotate from the position of FIG. 2. And, the closing spring 1 discharges a charged elastic energy to be in an extended state shown in FIG. 1. Here, the first rigid link 2 and the first linearly-movable shaft 4 connected to the ratchet wheel 7 linearly move to the left side.

The elastic energy discharged from the closing spring 1 may be transmitted to a movable contactor of the circuit breaker through a power transmission means (not shown) such as a link, the movable contactor connected to the first linearly-movable shaft 4. And, the elastic energy may be used to perform a circuit closing operation of the circuit breaker, i.e., an operation to drive the movable contactor to a position for connection to a fixed contactor.

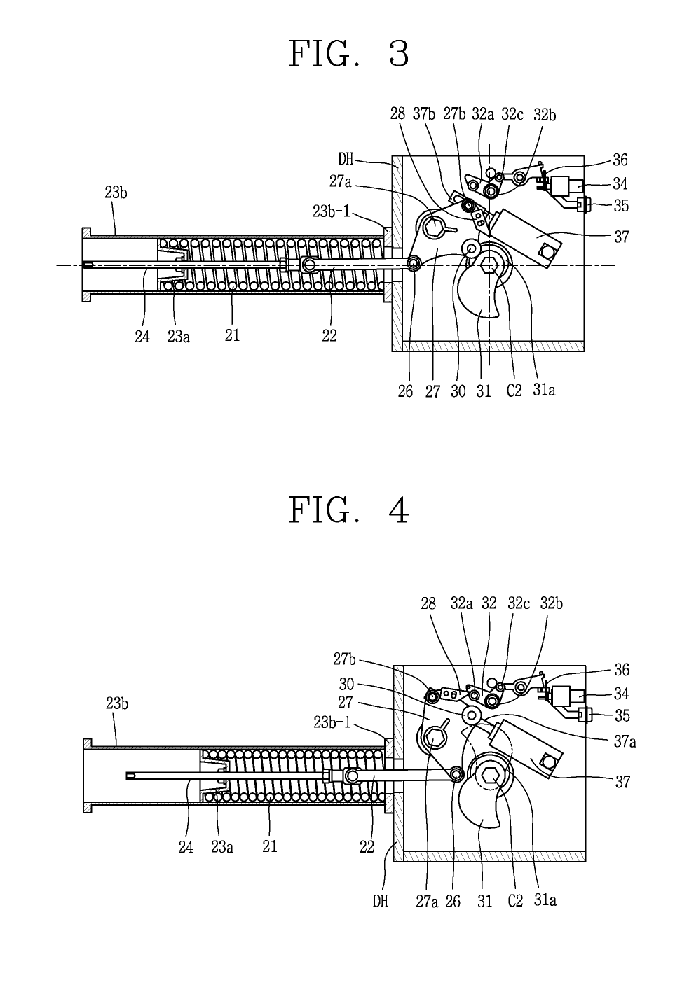

With reference to FIGS. 3 and 4, will be explained a configuration and an operation of the trip spring actuator according to a preferred embodiment of the present disclosure.

The trip spring actuator according to a preferred embodiment of the present disclosure comprises a trip spring 21, a second spring housing 23b, a second movable supporting plate 23a, a second linearly-movable shaft 24, a second driving mechanism 31, 31a, 27 and 27a, a second rigid link 22, and a second latch mechanism 28, 32, 33, 34, 35 and 36.

Referring to FIGS. 3 and 4, reference numeral 30 designates a roller rotatably installed at one side of a rotation plate 27, and configured to receive a driving power from the cam 31 of the second driving mechanism 31, 31a, 27 and 27a. Reference numeral 37 designates an shock absorbing cylinder. The shock absorbing cylinder 37 is a means for restricting a rotation range of the rotation plate 27 and absorbing an impact of the rotation plate 27. A cylinder rod 37a of the shock absorbing cylinder 37 is connected to the rotation plate 27.

Referring to FIGS. 3 and 4, reference numeral 37b designates a rod connecting member attached to a leading end (fore end) of the cylinder rod 37a, connected to the rotation plate 27, having a slit portion, and formed in a rectangular shape. Reference numeral 27b designates a third connection pin fitted into the slit portion of the rod connecting member 37b, and configured to connect the rod connecting member 37b and the rotation plate 27 to each other.

Referring to FIGS. 3 and 4, reference numeral 23b-1 designates flange portions formed at one end of the spring housing 23b, and extending from the one end of the spring housing 23b toward the center (inside) and the outside of the second spring housing 23b.

The flange portions 23b-1 support one end of the trip spring 21, and are fixed to a driving mechanism housing (DH) communicated with the second spring housing 23b by welding or by using coupling means (e.g., bolts and nuts).

The flange portions 23b-1 have a communication opening for communication with the driving mechanism housing (DH), through which the second link 22 is movable.

Referring to FIGS. 3 and 4, reference numeral 26 designates a second connection pin configured to connect the second linearly-movable shaft 24 and the second rigid link 22 to each other.

The trip spring 21 is a means to provide an elastic energy, a driving power for performing a trip operation of the circuit breaker, i.e., a circuit opening operation. In the present disclosure, the trip spring 21 is configured by a compression spring which charges an elastic energy when being compressed, and discharges a charged elastic energy when being extended.

The second spring housing 23b has the same configuration as the first spring housing 3b, and is configured by a hollow pipe. Two ends of the second spring housing 23b are open. As aforementioned, the flange portions 23b-1 are disposed at one end of the second spring housing 23b, thereby supporting the one end of the trip spring 21.

The second movable supporting plate 23a is configured to support another end of the trip spring 21. The second movable supporting plate 23a may be configured by a bell-shaped metallic plate having an outer diameter smaller than an inner diameter of the second spring housing 23b by a predetermined allowance, and having a predetermined thickness.

Referring to FIGS. 3 and 4, flange portions are provided at the left upper and lower ends of the second movable supporting plate 23a, thereby supporting another end of the trip spring 21.

The second movable supporting plate 23a has, at a central portion thereof, a threaded through hole portion meshed with a threaded surface of the second linearly-movable shaft 24 for coupling with the second linearly-movable shaft 24. Here, the threaded through hole portion allows the second linearly-movable shaft 24 to penetrate therethrough.

Nuts (not shown) may be additionally provided so as to prevent the second movable supporting plate 23a from being moved back by an elastic force of the trip spring 21.

The second linearly-movable shaft 24 is configured by a linear shaft connected to the second movable supporting plate 23a and linearly-movable together with the second movable supporting plate 23a, and is provided with a threaded surface on an outer surface thereof.

The second linearly-movable shaft 24 has a first position (i.e., the position of FIG. 4) for charging an elastic energy serving as a driving power to perform a circuit closing operation of the circuit breaker by compressing the trip spring 21, and has a second position (i.e., the position of FIG. 3) for releasing the trip spring 21 so that the trip spring 21 can discharge the charged elastic energy.

The second driving mechanism 31, 31a, 27 and 27a configured to provide a rotatory power for linearly-moving the second linearly-movable shaft 24 comprises a cam 31, a cam shaft 31a for supporting the cam 31, a rotation plate 27 and a rotation shaft 27a.

The cam shaft 31a may be rotated in a manual manner or in a motor-operated manner by being connected to a handle (not shown) or a motor (not shown).

The cam 31 is rotatable according to rotation of the wheel shaft 7a, and has a cam profile, i.e., an outer circumferential surface of the cam 31 has a varying curvature radius.

As can be seen from the dot-and-dash line of FIG. 3, the centers of the trip spring 21, the second linearly-movable shaft 24 and the second rigid link 22 are positioned at the same height as the center (C2) of the cam 31.

The rotation plate 27 is rotatable centering around the rotation shaft 27a, which is installed to overlap a rotation radius of the cam 31 so as to receive a driving power by a contact pressure of the cam 31.

The rotation plate 27 is formed in a quadrangular shape having four vertexes. A first vertex eccentric from the center is configured to accommodate the rotation shaft 27a therein, and a second vertex disposed on the lower side is connected to the second rigid link 22 by a second connection pin 26. A third vertex disposed on the upper side is connected to the rod connecting member 37b of the shock absorbing cylinder 37 by a third connection pin 27b. On a fourth vertex, rotatably installed is a roller 30 contacting the cam 31 and receiving a rotatory power from the cam 31.

A third latch 28 is fixedly installed at one side adjacent to the third vertex. The rotation plate 27 is rotatable centering around the rotation shaft 27a by a rotatory power provided from the cam 31 through the roller 30. And, the rotation plate 27 transmits the rotatory power, to the second rigid link 22 connected to the second vertex by the second connection pin 26.

The rotation shaft 27a provides a rotation supporting point to the rotation plate 27 so that the rotation plate 27 can rotate.

The second rigid link 22 has one end connected to the rotation plate 27 and another end connected to the second linearly-movable shaft 24, so that the rotatory power received, through the rotation plate 27, from the cam 31 of the second driving mechanism 31 and 31a can be converted into a linear power, and the linear power can be transmitted to the second linearly-movable shaft 24.

The second rigid link 22 and the second linearly-movable shaft 24 are connected to each other by a joint member (not shown) and a connection pin (not shown).

The joint member is configured by a pipe-type metallic member. One end of the joint member has a threaded connection portion meshed with the threaded surface of the second linearly-movable shaft 24 as an inner surface thereof is configured by a threaded portion, and another end of the joint member link-connected to the second rigid link 22 by a connection pin so as to allow rotation of the second rigid link 22. Accordingly, the second rigid link 22 is rotatable centering around the connection pin.

A rotation range of the second rigid link 22 may be limited by a diameter of a through hole formed at the driving mechanism housing (DH) and configured to allow the second rigid link 22 to be movable by penetrating therethrough.

Preferably, the second rigid link 22 is configured by a linear link.

As can be seen from the dot-and-dash line of FIG. 3, the centers of the trip spring 21, the second linearly-movable shaft 24 and the second rigid link 22 are positioned at the same height as the center (C2) of the cam 31. Under this configuration, a rotatory power of the cam 31 may be transmitted to the trip spring 21 in a straight line manner, through the second rigid link 22, the second linearly-movable shaft 24 and the second movable supporting plate 23a, and a power loss can be minimized.

Since the second rigid link 22 is configured by the linear link, the structure to convert a rotatory power into a linear power and to transmit the linear power to the second linearly-movable shaft 24 may be simplified. This may enhance the reliability, and facilitate the fabrication and the design of the spring actuator for a circuit breaker.

The second latch mechanism 28, 32, 33, 34, 35 and 36 have a position for latching the trip spring 21 so that the trip spring 21 can maintain a charged state, and have a position for releasing the trip spring 21 so that the trip spring 21 can discharge the charged elastic energy.

The second latch mechanism 28, 32, 33, 34, 35 and 36 comprises a third latch 28, a latch holder 32, a lever 33, an opening coil 34, an opening button 35 and a fourth latch 36.

The third latch 28 is fixedly installed at one side adjacent to the third vertex of the rotation plate 27. And, the third latch 28 is configured by a piece having a supporting part fixed to the third vertex by a connection means such as a rivet, and an extension part extending from the supporting part to the outside of the rotation plate 27. The third latch 28 rotates together with the rotation plate 27.

The latch holder 32 is installed within a rotation path of the third latch 28 according to rotation of the rotation plate 27. And, the latch holder 32 is configured by a ‘V’-shaped lever having a position for latching the third latch 28, and a position for releasing the third latch 28. A latch holder shaft 32b is fixedly installed at a central part of the ‘V’-shaped latch holder 32, thereby providing a rotation supporting point for rotating the latch holder 32. And, a latch holder pin 32a is installed at one end of the ‘V’-shaped latch holder 32, thereby latching or releasing the third latch 28.

Another end of the ‘V’-shaped latch holder 32 is connected to the lever 33 through a fourth connection pin 32c.

The lever 33 is a member rotatable about a central shaft. The lever has one end connected to the latch holder 32 through the fourth connection pin 32c, and another end contactable to the fourth latch 36. As the another end of the lever 33 is connected to a bias spring (not shown), the lever 33 is elastically pressed by the bias spring so as to counterclockwise rotate.

The fourth latch 36 may be configured by a lever having a central shaft, one end and another end, and rotatable about the central shaft. Here, the central shaft of the fourth latch 36 has a semicircular section, and is configured to press the lever 33 by contacting another end of the lever 33, or configured to release the lever 33. The one end of the fourth latch 36 is extending from the central shaft so as to receive a manual power from the aforementioned opening button 35, and connected to the opening button 35. And, the another end of the fourth latch 36 is extending to the opening coil 34 so as to receive a power from the opening coil 34.

The one end of the fourth latch 36 may be also connected to the opening button 35 for power transmission, and may rotate so as to release the first latch 9 when the opening button 35 is pressed. The fourth latch 36 is disposed at a position where the lever 33 is latched when a planar part of a semicircle of the central shaft is toward the lever 33, and is disposed at a position where the lever 33 is released when a curve part of the semicircle of the central shaft is toward the lever 33.

The opening button 35 is connected to the fourth latch 36 of the second latch mechanism 28, 32, 33, 34, 35 and 36, and allows a user to perform a circuit closing operation of the circuit breaker. And, the opening button 35 is configured to transmit a user's pressing power to the fourth latch 36.

The opening coil 34 comprises a coil (not shown) configured to generate an electromagnetic force by being magnetized by an electric control signal, a plunger (not shown) linearly-movable by an electromagnetic force generated from the coil, and a return spring (not shown) configured to return the plunger to an initial position.

Once the coil is magnetized by an electric control signal provided from a controller (not shown), the plunger forward linearly-moves to a position protruded to the outside of the opening coil 34 by an electromagnetic force generated from the coil.

Once the coil is demagnetized as the supply of the electric control signal from the controller (not shown) is stopped, the plunger backward linearly-moves to a non-protruded position from the protruded position by an elastic force of the return spring.

The operation of the trip spring actuator according to a preferred embodiment of the present disclosure will be explained.

Firstly, a charging operation of the trip spring will be explained.

In the state shown in FIG. 3, the cam 31 is clockwise rotated by a handle (manipulated by a user) or a motor. As a result, the roller 30 of the rotation plate 27 contacting an outer circumferential surface of the cam 31 comes in contact with the outer circumferential surface having a large curvature radius. This may cause the rotation plate 27 to counterclockwise rotate.

At a position of FIG. 4 where the roller 30 of the rotation plate 27 comes in contact with an outer circumferential surface of the cam 31 having a largest curvature radius (refer to the two dots-and-dash line of FIG. 4, which indicates the position of the cam), the third latch 28 is stopped by being locked by the latch holder pin 32a of the latch holder 32. As a result, the third latch 28 is latched at the position.

According to the counterclockwise rotation of the rotation plate 27, the second rigid link 22 having one end connected to the second vertex of the rotation plate 27 by the second connection pin 26 linearly moves to the right side.

As a result, the second linearly-movable shaft 24 connected to another end of the second rigid link 22, and the second movable supporting plate 23a connected to the second linearly-movable shaft 24 linearly move to the right side. This may cause the trip spring 21 to be compressed to charge an elastic energy.

Here, a curve part of a semicircle of the central shaft is disposed toward the lever 33 so that the lever 33 can be latched in a contact manner. Accordingly, the lever 33 is latched so as to prevent from counterclockwise rotating.

Furthermore, as the third latch 28 is latched by being locked by the latch holder pin 32a, the trip spring 21 maintains the charged state (trip standby state). Even if the cam 31 more rotates clockwise in this state (refer to the position of the cam 31 indicated by the solid line in FIG. 4), the trip spring 21 maintains the charged state (trip standby state) because the third latch 28 is latched by being locked by the latch holder pin 32a.

Next, will be explained a discharging operation of the trip spring for a trip operation of the circuit breaker.

In the trip standby state of FIG. 4, the plunger may move to a position protruded to the outside of the opening coil 34 as the opening coil 34 is magnetized by an electric control signal provided from a controller (not shown) of the circuit breaker. Alternatively, a power of the opening button 35 may be transmitted to the fourth latch 36 when the opening button 35 is pressed by a user. In this case, the fourth latch 36 is pressed to rotate, because the plunger is pressed by the opening coil 34 contacting another end of the fourth latch 36, or because a power of the closing button 11 pressed by a user is transmitted to one end of the second latch 12.

As a curve part of the semicircle of the central shaft of the fourth latch 36 is toward the lever 33 to release the lever 33, the lever 33 counterclockwise rotates by the bias spring.

As a result, the latch holder 32 connected to one end of the lever 33 clockwise rotates from the position of FIG. 4, thereby releasing the third latch 28. And, the trip spring 21 discharges a charged elastic energy to be in an extended state shown in FIG. 3. Here, the second rigid link 22 and the second linearly-movable shaft 24 connected to the rotation plate 27 linearly move to the left side.

The elastic energy discharged from the trip spring 21 may be transmitted to a movable contactor of the circuit breaker through a power transmission means (not shown) such as a link, the movable contactor connected to the second linearly-movable shaft 24. And, the elastic energy may be used to perform a trip operation, i.e., an operation to drive the movable contactor to a position for disconnection from a fixed contactor.

During the discharging operation of the trip spring 32, the rotation plate 27 instantaneously rotates to a clockwise direction. And, the cylinder rod 37a connected to the rotation plate 27 by the third connection pin 27b backward moves to the position of FIG. 3, from the position of FIG. 4. At the same time, a fluid or a gas inside the shock absorbing cylinder 37 is compressed, and an impact of the rotation plate 27 is absorbed. Here, the third connection pin 27b fitted into the slit of the rod connecting member 37b also backward moves in the slit.

The spring actuator for a circuit breaker according to the present disclosure may have the following advantages.

Firstly, the spring actuator according to the present disclosure comprises one rigid link having one end connected to the driving mechanism and another end connected to the movable supporting plate, instead a chain and a guide roller for guiding the chain, so that a rotatory power from the driving mechanism can be converted into a linear power to be transmitted. This may enhance the durability and the reliability. Furthermore, design changes for enhancing an output from the spring actuator may be easily performed by changing a thickness and a length of the rigid link.

Secondly, the driving mechanism comprises the rotatable ratchet wheel, and the centers of the spring, the linearly-movable shaft and the rigid link are positioned at the same height as the center of the ratchet wheel. Under this configuration, a rotatory power of the ratchet wheel may be transmitted to the spring through the rigid link in a straight line manner, and a power loss may be minimized.

Thirdly, the driving mechanism comprises the rotatable cam, and the centers of the spring, the linearly-movable shaft and the rigid link are positioned at the same height as the center of the cam. Under this configuration, a rotatory power of the cam may be transmitted to the spring through the rigid link in a straight line manner, and a power loss may be minimized.

Fourthly, since the rigid link is configured by a linear link, the structure to convert a rotatory power into a linear power and to transmit the linear power to the linearly-movable shaft may be simplified. This may enhance the reliability, and facilitate the fabrication and the design of the spring actuator for a circuit breaker.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A spring actuator for a circuit breaker, the spring actuator comprising:
a spring configured to provide an elastic energy serving as a driving power to perform a circuit opening operation or a circuit closing operation of a circuit breaker;
a spring housing configured to support one end of the spring, and providing a space to compress or extend the spring;
a movable supporting plate configured support another end of the spring, and linearly movable in the spring housing;
a linearly-movable shaft linearly-movable together with the movable supporting plate in a connected state to the movable supporting plate, having a first position for charging an elastic energy serving as a driving power to perform a circuit opening operation or a circuit closing operation of a circuit breaker by compressing the spring, and having a second position for releasing the spring such that the spring discharges the charged elastic energy;
a driving mechanism configured to provide a rotatory power for linearly-moving the linearly-movable shaft;
a rigid link having one end connected to the driving mechanism and another end connected to the linearly-movable shaft, and configured to convert the rotatory power provided from the driving mechanism to a linear power and to transmit the linear power to the linearly-movable shaft; and
a latch mechanism having a position for latching the spring such that the spring maintains a charged state, and having a position for releasing the spring such that the spring discharges the charged elastic energy.

2. The spring actuator of claim 1, wherein the driving mechanism comprises a rotatable ratchet wheel, and
wherein each center of the spring, the linearly-movable shaft and the rigid link is positioned at the same height as the center of the ratchet wheel.

3. The spring actuator of claim 1, wherein the driving mechanism comprises a rotatable cam, and
wherein each center of the spring, the linearly-movable shaft and the rigid link is positioned at the same height as the center of the cam.

4. The spring actuator of claim 1, wherein the rigid link is configured by a linear link.

5. The spring actuator of claim 2, wherein the rigid link is configured by a linear link.

6. The spring actuator of claim 3, wherein the rigid link is configured by a linear link.
